(19) United States
(12) Patent Application Publication
(10) Pub. No.: US 2008/0133899 A1
(43) Pub. Date: Jun. 5, 2008

(54) Context switching method, medium, and system for reconfigurable processors

(75) Inventors: Jung-keun Park, Seoul (KR); Gyu-sang Choi, Seoul (KR); Chae-seok Im, Suwon-si (KR); Chang-woo Baek, Hwaseong -si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/987,662

(22) Filed: Dec. 3, 2007

(30) Foreign Application Priority Data
Dec. 4, 2006 (KR) 10-2006-0121615

(51) Int. Cl. G06F 9/318

(52) U.S. Cl. 712/229; 712/E09.035

(57) ABSTRACT

A context switching method, medium, and system with a reconfigurable processor. The context switching system include a reconfigurable processor reconfiguring a program according to reconfiguration information and executing the reconfigured program, a central processing unit outputting a load command for sequentially loading reconfiguration information required for a plurality of tasks, in order to control the plurality of tasks, a reconfiguration information selecting unit selecting reconfiguration information for context switching, a reconfiguration information loading unit receiving the load command from the central processing unit, and loading reconfiguration information corresponding to the load command from a memory, and a plurality of reconfiguration information storage units storing the reconfiguration information loaded by the reconfiguration information loading unit. Accordingly, by pre-loading reconfiguration information which is required many times while context switching is performed, it is possible to quickly perform context switching and perform multitasking with a small overhead.

### CROSS-REFERENCE TO RELATED APPLICATIONS

This application claims the benefit of Korean Patent Application No. 10-2006-0121615, filed on Dec. 4, 2006, in the Korean Intellectual Property Office, the disclosure of which is incorporated herein in its entirety by reference.

### BACKGROUND

1. Field of the Invention

One or more embodiments of the present invention relate to an operating system for driving an embedded system, such as a mobile device, a multimedia device, or a home device, in which a reconfigurable processor may be used, and more particularly, to a method, medium, and system reducing the overhead of context switching in a multitasking environment of a reconfigurable processor. In one or more embodiments, a plurality of reconfiguration information storage spaces may be provided to store predicted reconfiguration information, thereby reducing the overhead of managing the reconfiguration information.

2. Description of the Related Art

Multitasking can be an indispensable function of the operating systems of computers and embedded systems, allowing them to perform a plurality of tasks concurrently.

In order to implement multitasking, context switching has been used. Context switching is a switch process which assigns the central processing unit (CPU) from one process to another. A most important issue in context switching is to reduce the overhead caused by the context switching.

The context of a task includes a variety of information. In conventional systems using CPUs or digital signal processing (DSP) units, the contents of the processor's registers include the context information. The overhead of context switching is typically proportional to the number of registers that are to be stored and restored. Conventionally, in order to reduce the overhead of context switching, techniques for reducing the contexts of registers have been used. However, systems using a reconfigurable processor must include reconfiguration information and register information of the reconfigurable processor, as well as register information of a processor, in contexts. Since the reconfiguration information and register information of the reconfigurable processor are large, and a separate amount of time is needed to reconfigure the reconfigurable processor when context switching is performed, the overhead of context switching becomes large.

Another conventional technique is to analyze a single task in an environment in which the single task is performed, and pre-load reconfiguration information required to perform the single task. In addition, a technique has been developed of loading required reconfiguration information for a plurality of reconfigurable processors when multi tasking is performed. However, these conventional techniques are very slow when context switching is performed for multitasking. Further, if multiple reconfigurable processors are used in order to resolve such problems, system manufacturing costs increase.

### SUMMARY

One or more embodiments of the present invention provide a context switch method, medium, and system for a reconfigurable processor that can minimize the time required for multitasking without increasing system manufacturing costs by selectively pre-loading reconfiguration information required for context switching when multitasking is performed.

Additional aspects and/or advantages of the invention will be set forth in part in the description which follows and, in part, will be apparent from the description, or may be learned by practice of the invention.

To achieve the above and/or other aspects and advantages, embodiments of the present invention include a system with context switching for a reconfigurable processor, including a controller with reconfiguration information loading to selectively control a current loading of corresponding reconfiguration information, based upon a particular load command, for the reconfigurable processor for a task from a memory maintaining a plurality of reconfiguration information based upon a determination of whether the corresponding reconfiguration information is pre-stored in at least one of a plurality of reconfiguration information storage units separate from the memory.

To achieve the above and/or other aspects and advantages, embodiments of the present invention include a context switching method, the method including selectively loading, based upon a load command, corresponding reconfiguration information for reconfiguring a reconfigurable processor for a task from a memory maintaining a plurality of reconfiguration information based upon a determination of whether the corresponding reconfiguration information is pre-stored in at least one of a plurality of reconfiguration information storage units separate from the memory, and selecting the corresponding reconfiguration information for context switching of the corresponding reconfiguration information for a next task of the reconfigurable processor.

To achieve the above and/or other aspects and advantages, embodiments of the present invention include a context switching method, including performing context switching of register information for performing a current task of a reconfigurable processor, determining whether corresponding reconfiguration information for the current task for reconfiguring the reconfigurable processor is stored in any of a plurality of reconfiguration information storage units, outputting a load command for loading the corresponding reconfiguration information from a memory maintaining a plurality of reconfiguration information if the corresponding reconfiguration information is determined to not be stored in any of the plurality of reconfiguration information storage units, selectively loading the corresponding reconfiguration information from the memory and storing the corresponding reconfiguration information in one of the plurality of reconfiguration information storage units, separate from the memory, and selecting the corresponding reconfiguration information, as stored in the one of the plurality of reconfiguration information storage units, for context switching of the corresponding reconfiguration information for a current task.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a context switch system having a reconfigurable processor, according to an embodiment of the present invention;

FIGS. 2A-2B respectively illustrate examples of reconfiguration information stored in first and second reconfiguration information storage units, such as those illustrated in FIG. 1, according to an embodiment of the present invention;

FIG. 3 illustrates a timing diagram explaining a context switching process, according to an embodiment of the present invention;

FIG. 4 illustrates a context switch method, according to an embodiment of the present invention;

FIG. 5 illustrates an operation 202, such as illustrated in FIG. 4, according to an embodiment of the present invention; and

FIG. 6 illustrates a context switch method, according to another embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

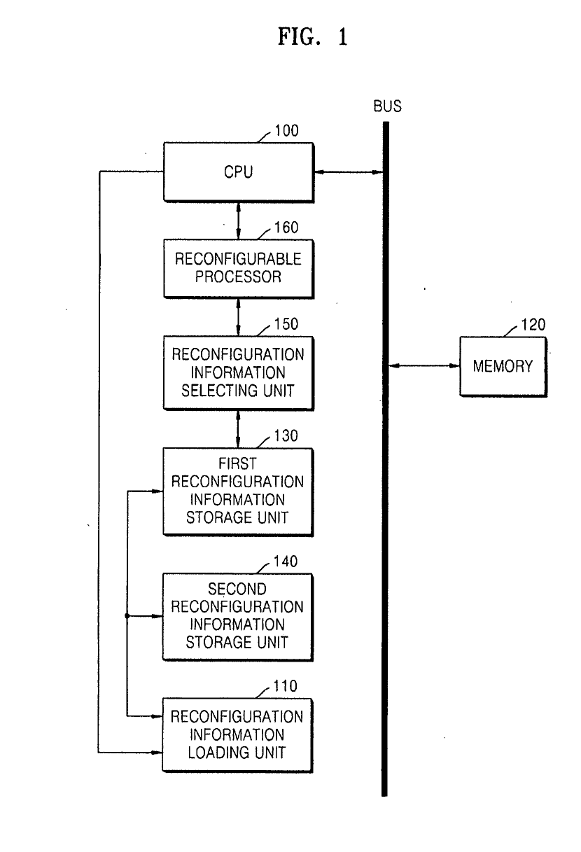

FIG. 1 illustrates a context switch system with a reconfigurable processor, according to an embodiment of the present invention.

Referring to FIG. 1, the context switch system may include a central processing unit (CPU) 100, a reconfiguration information loading unit 110, a memory 120, a first reconfiguration information storage unit 130, a second reconfiguration information storage unit 140, a reconfiguration information selection unit 150, and a reconfigurable processor 160, for example. Here, although the illustrated context switch system is shown as including two reconfiguration information storage units 130 and 140, embodiments of the present invention are not limited thereto. As one example, the context switch system may include n reconfiguration information storage units, wherein n is an integer greater than 2.

The CPU 100, for example, may control multiple tasks that are to be performed by the context switch system. In order to control these tasks, the CPU 100 may sequentially command the reconfiguration information loading unit 110 to load reconfiguration information required to perform the plurality of tasks. That is, the CPU 100 may predict reconfiguration information required to perform the next task, e.g., using scheduling information of the tasks, and output a load command for loading the predicted reconfiguration information, to the reconfiguration information loading unit 110. Here, the scheduling information can be managed by a scheduler of an operating system. Thus, in an embodiment, the CPU 100 dynamically predicts reconfiguration information for the next task, which is to be performed after the current task is performed, using the scheduling information.

In the case of fixed-order scheduling information, the CPU 100 may output a load command for loading reconfiguration information corresponding to the task that is to be performed next in sequence, to the reconfiguration information loading unit 110, for example. In the case of time-based scheduling information, the CPU 100 may output a load command for loading reconfiguration information corresponding to the task that is to be performed in the next time period, to the reconfiguration information loading unit 110, again as an example. The load command can be output whenever the scheduling information changes. When a change occurs in the scheduling information, the CPU 100 can dynamically predict reconfiguration information for the next task, and output a load command for loading the predicted reconfiguration information, to the reconfiguration information loading unit 110. Here, the scheduling information is changed in the case where the task order changes when a different task is required by a user while the current task is performed, or in the case where the task order is changed internally to enhance task processing efficiency.

Thus, in such an embodiment, the reconfiguration information loading unit 110 may receive the load command from the CPU 100, and load the corresponding reconfiguration information from the memory 120, for example, in response to the load command. Prior to the loading, the reconfiguration information loading unit 110 may determine whether the reconfiguration information corresponding to the load command of the CPU 100 is stored in the first reconfiguration information storage unit 130 or the second reconfiguration information storage unit 140, for example.

If the reconfiguration information corresponding to the load command of the CPU 100 is stored in either the first reconfiguration information storage unit 130 or the second reconfiguration information storage unit 140, the reconfiguration information loading unit 110 may not load the reconfiguration information corresponding to the load command of the CPU 100. The reconfiguration information may not be loaded because it does not need to be loaded, since it is already stored in the first reconfiguration information storage unit 130 or the second reconfiguration information storage unit 140.

However, if the reconfiguration information corresponding to the load command is not stored or found to be stored in either the first reconfiguration information storage unit 130 or the second reconfiguration information storage unit 140, the reconfiguration information loading unit 110 can load the reconfiguration information corresponding to the load command, from the memory 120, e.g., through the illustrated bus.

In such an embodiment, the memory 120 may store a plurality of pieces of reconfiguration information required to perform multiple tasks for use at a future time, for example, and a plurality of programs required to drive the context switch system. In one embodiment, for example, the memory 120 may be a dynamic random access memory (DRAM). Conversely, the first reconfiguration information storage unit 130 and the second reconfiguration information storage unit 140 may store reconfiguration information that may be for more imminent use.

Thus, here, the memory 120 may receive a load request from the reconfiguration information loading unit 110, and output the corresponding reconfiguration information, to the reconfiguration information loading unit 110 through the bus, e.g., in response to the load request. The reconfiguration information loading unit 110 may further output, or cause to be forwarded, the reconfiguration information loaded from the memory 120 to either the first reconfiguration information storage unit 130 or the second reconfiguration information storage unit 140.

In this example, the first reconfiguration information storage unit 130 and the second reconfiguration information storage unit 140 may store the reconfiguration information loaded by the reconfiguration information loading unit 110. The first reconfiguration information storage unit 130 and the second reconfiguration information storage unit 140 may function as cache memories for allowing the reconfigurable processor 160 to quickly access reconfiguration information. For example, if the first reconfiguration information storage unit 130 stores reconfiguration information for the task that is currently being performed, the second reconfiguration information storage unit 140 may store reconfiguration information for the task that is to be performed next, according to a load command of the CPU 100. Alternatively, if the second reconfiguration information storage unit 140 stores reconfiguration information for the task that is currently being performed, the first reconfiguration information storage unit 130 may store reconfiguration information for the next task.

The reconfiguration information stored in the first reconfiguration information storage unit 130 and the second reconfiguration information storage unit 140 may include unique identifiers for identifying the reconfiguration information, reconfiguration data for reconfiguring programs, and status information indicating whether the reconfiguration information is available, for example.

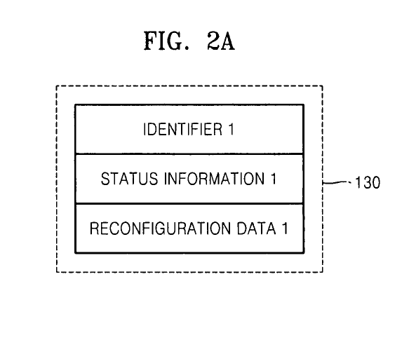

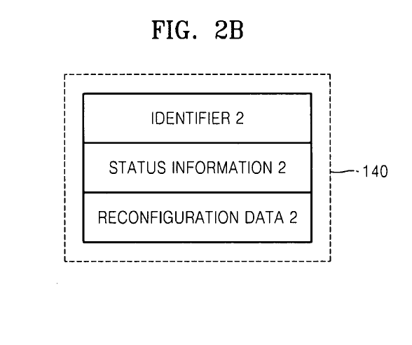

FIGS. 2A and 2B respectively illustrate examples of reconfiguration information stored in the first and second reconfiguration information storage units 130 and 140, such as those illustrated in FIG. 1, according to an embodiment of the present invention. The illustrated identifiers 1 and 2 can be used to uniquely represent reconfiguration information, and can be set according to address information of the memory 120 storing reconfiguration information, or can be arbitrary values, and the reconfiguration data can be data regarding programs that are to be reconfigured to perform tasks. The status information may further indicate whether the reconfiguration information stored in the first and second reconfiguration information storage units 130 and 140 is available, or whether current reconfiguration information is currently being loaded and cannot yet be used.

For context switching of the reconfiguration information for the next task, the reconfiguration information selection unit 150 may select reconfiguration information for the next task. That is, in this example, the reconfiguration information selection unit 150 may select a piece of the reconfiguration information stored in the first and second reconfiguration information storage units 130 and 140, and the reconfiguration processor 160 can operate according to the selected reconfiguration information.

When the reconfiguration information for the next task is selected by the reconfiguration information selection unit 150, e.g., from the first and second reconfiguration information storage units 130 and 140, the reconfigurable processor 160 may reconfigure the corresponding program according to the selected reconfiguration information, and then execute the reconfigured program.

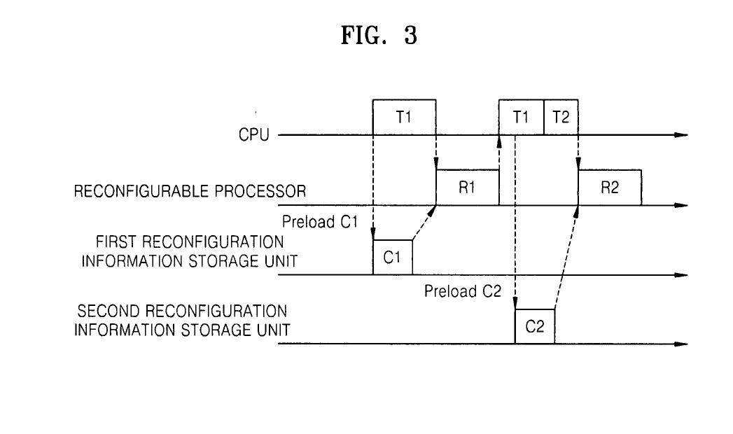

FIG. 3 illustrates a timing diagram explaining a context switching process, according to an embodiment of the present invention. FIG. 3 illustrates the example of a process of loading reconfiguration information when two tasks T1 and T2 are performed. Further, in this example, the tasks T1 and T2 may be performed by the CPU 100 and the reconfigurable processor 160. Accordingly, the task T1 may be performed using reconfiguration information C1, and the task T2 performed using reconfiguration information C2. In addition, as illustrated, the task T1 is performed before the task T2 is performed. Accordingly, here, first, the CPU 100 may process the task T1. In order to process the task T1, the CPU 100 can perform context switching of register information. Further, after the context switching of the register information is performed, the CPU 100 may output a load command for loading the reconfigurable information C1 for processing the task T1, while processing the task T1. The reconfigurable information C1 corresponding to the load command can be loaded from the memory 120, for example, and stored in the first reconfiguration information storage unit 130. By loading the reconfiguration information C1 for the task T1 while the CPU 100 processes the task T1, no separate or additional time is needed for loading the reconfiguration information C1. Thereafter, the reconfigurable processor 160 may reconfigure a program R1 according to the reconfiguration information C1 stored in the first reconfiguration information storage unit 130, and execute the program R1. The CPU 100 may then perform the remaining processing of the task T1 and begin processing of the task 2. When the CPU 100 performs the remaining processing of the task T1, the CPU 100 may output a load command for loading reconfiguration information C2 for performing the next task T2, to the reconfiguration information loading unit 110, load the reconfiguration information C2 for the task T2 from the memory 120, and store the reconfiguration information C2 in the second reconfiguration information storage unit 140. By loading the reconfiguration information C2 for the task 2 while performing the remaining processing of the task T1, no separate or additional time is needed for loading the reconfiguration information C2.

In this example, after the CPU 100 processes the task T2, the reconfigurable processor 160 may reconfigure a program R2 according to the reconfiguration information C2 stored in the second reconfiguration information storage unit 140, and then execute the reconfigured program R2.

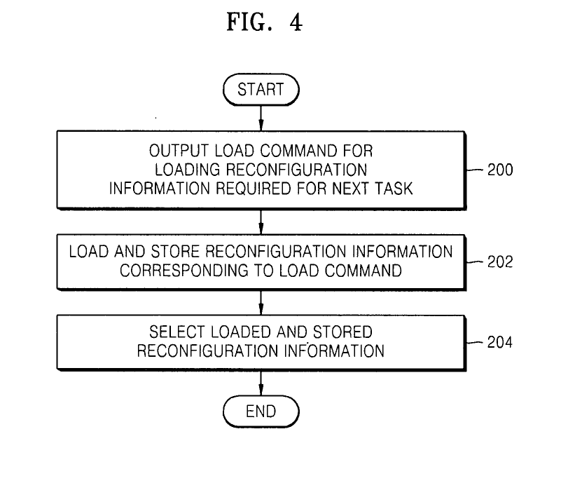

FIG. 4 illustrates a context switching method, according to an embodiment of the present invention.

In operation 200, a load command may be output for loading reconfiguration information desired for the next task that is to be performed. For example, referring to the above FIGS. 1 and 3 examples, while the remaining processing of the task T1 is performed by the CPU 100, the CPU 100 may output a load command for loading reconfiguration information C2 required for a task T2, to the reconfiguration information loading unit 110, for example.

In operation 200, reconfiguration information for the task that is to be performed next may be predicted, e.g., using scheduling information for tasks, and a load command may be output for loading the predicted reconfiguration information.

In the case of fixed-order scheduling information, a load command may be output for loading reconfiguration information corresponding to the task that is to be performed next in sequence. In the case of time-based scheduling information, a load command may be output for loading reconfiguration information corresponding to the task that is to be performed in the next time period.

The load command may be output whenever scheduling information changes. Further, when scheduling information changes, the CPU 100 may dynamically predict reconfiguration information for the next task, and output a load command for loading the predicted reconfiguration information, e.g., to the reconfiguration information loading unit 110. For example, a load command may be output in the case where the task order changes when a different task is required by a user while the current task is being performed, or in the case where the task order is changed internally in order to enhance task processing efficiency.

After operation 200, in operation 202, reconfiguration information corresponding to the load command may be loaded from a memory, for example, and further stored in one of a plurality of reconfiguration information storage units.

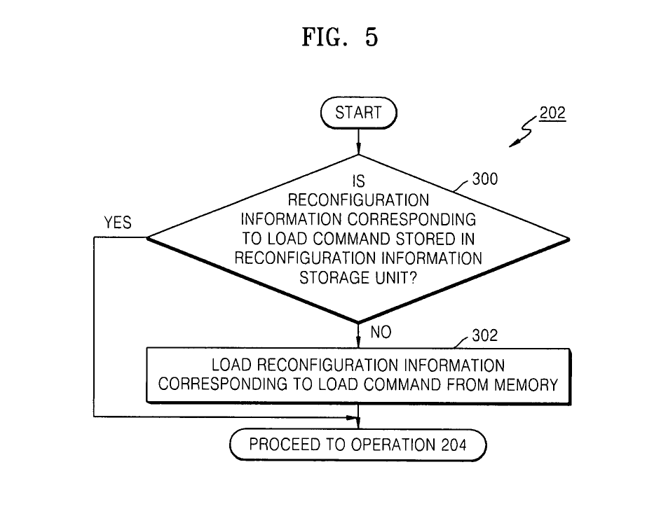

FIG. 5 illustrates an operation 202, such as that illustrated in FIG. 4, according to an embodiment of the present invention.

In operation 300, it may be determined whether the reconfiguration information corresponding to the load command is stored in one of the plurality of reconfiguration information storage units. For example, referring to FIG. 1, if the plurality of reconfiguration information storage units are the first reconfiguration information 130 and the second reconfiguration information storage unit 140, the reconfiguration information loading unit 110 may determine whether the reconfiguration information corresponding to the load command of the CPU 100 is stored in either the first reconfiguration information storage unit 130 or the second reconfiguration information storage unit 140.

In this example, if the reconfiguration information corresponding to the load command of the CPU 100 is stored in either the first reconfiguration information storage unit 130 or the second reconfiguration information storage unit 140, the process may proceed to the aforementioned operation 204 of FIG. 4. The process may proceed to operation 204 because the reconfiguration information may not need to be loaded, since it is already stored in the first reconfiguration information storage unit 130 or the second reconfiguration information storage unit 140.

However, here, if the reconfiguration information corresponding to the load command is not stored in one of the plurality of reconfiguration information storage units, the reconfiguration information corresponding to the load command may be loaded from the memory, in operation 302. For example, referring to FIG. 1, if the reconfiguration information corresponding to the load command of the CPU 100 is not stored in either the first reconfiguration information storage unit 130 or the second reconfiguration information storage unit 140, the reconfiguration information loading unit 110 may load the reconfiguration information corresponding to the load command, from the memory 120 through a bus. The reconfiguration information loading unit 110 may, thus, output the reconfiguration information loaded from the memory 120 to either the first reconfiguration information storage unit 130 or the second reconfiguration information storage 140, for example.

As noted above, the reconfiguration information stored in the plurality of reconfiguration information storage units may include unique identifiers for identifying the reconfiguration information, reconfiguration data for reconfiguring programs, and status information indicating whether the reconfiguration information is available, for example.

Further, here, the identifiers may be used to uniquely represent the reconfiguration information, and set by address information of the memory 120, for example, storing the reconfiguration information, or can be arbitrary values, as another example. The reconfiguration data is data regarding programs that are to be reconfigured to perform tasks. In addition, the status information may indicate whether reconfiguration information stored in a reconfiguration information storage unit is available, or whether current reconfiguration information is currently being loaded and cannot yet be used, for example.

After operation 202, for context switching of the reconfiguration information for the next task, the loaded and stored reconfiguration information may be selected, in operation 204. Referring to FIG. 1, for example, the appropriate reconfiguration information storage unit storing the reconfiguration information for the next task may be selected by the reconfiguration information selection unit 150, and then the reconfigurable processor 160 may reconfigure a program according to the selected reconfiguration information and execute the reconfigured program.

One or more embodiments of the present invention also include at least one medium comprising computer readable code to control at least one processing element to implement a method including generating a load command for loading reconfiguration information required for the next task that is to be performed after the current task, loading reconfiguration information corresponding to the load command from a memory, and storing the reconfiguration information in one of a plurality of reconfiguration information storage units, and executing the loaded and stored reconfiguration information for context switching of the reconfiguration information required for the next task, noting that alternatives are equally available.

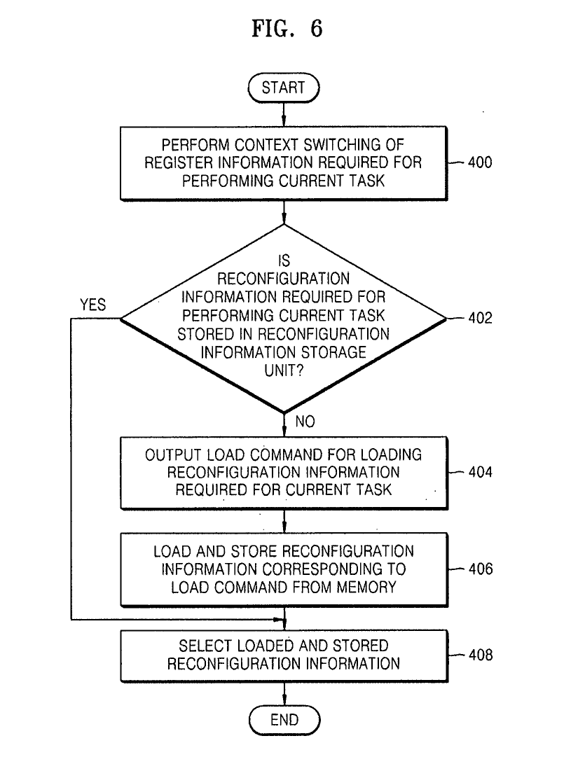

FIG. 6 illustrates a context switch method, according to another embodiment of the present invention.

First, context switching of register information for performing the current task may be performed, in operation 400. For example, referring to FIG. 3, in order to perform a task T1, context switching of register information and reconfiguration information for the task T1 is desired. The context switching of the register information for performing the task T1 may then be performed by the CPU 100 of FIG. 1, for example.

After operation 400, it may be determined whether reconfiguration information desired for the current task is stored in one of a plurality of reconfiguration information storage units, in operation 402. For example, referring to FIGS. 1 and 3, after the context switching for the register information is performed, the CPU 100 may determine whether reconfiguration information C1 required for a task T1 is stored in either the first or second reconfiguration information storage units 130 and 140.

If the reconfiguration information for the current task is stored in one of the plurality of reconfiguration information storage units, the reconfiguration information for the current task may not need to be loaded, so the process may proceed to operation 408.

However, if the reconfiguration information for the current task is not stored in one of the plurality of reconfiguration information storage units, a load command may be output for loading the reconfiguration information for the current task, in operation 404. For example, referring to FIG. 3, the CPU 100 may output a load command for loading reconfiguration information C1 required for performing a task T1 to the reconfiguration information loading unit 110.

After operation 404, the reconfiguration information corresponding to the load command may be loaded from a memory, for example, and stored in one of the plurality of reconfiguration information storage units, in operation 406. For example, referring to FIGS. 1 and 3, reconfiguration information C1 corresponding to a load command is loaded from the memory 120 and stored in the first reconfiguration information storage unit 130. Accordingly, since the reconfiguration information C1 for the task T1 is pre-loaded and stored in the first reconfiguration information storage unit 130 while the CPU 100 processes the task T1, no separate or additional time is needed for loading the reconfiguration information C1.

After operation 406, for context switching of the reconfiguration information for the current task, the loaded and stored reconfiguration information may be selected, in operation 408. Referring to FIG. 1, again in this example, since the reconfiguration information storage unit storing the reconfiguration information for the current task is selected by the reconfiguration information selection unit 150, the reconfigurable processor 160 may reconfigure a program according to the selected reconfiguration information and execute the reconfigured program.

One or more embodiments of the present invention also include at least one medium comprising computer readable code to control at least one processing element to implement a method including performing context switching of register information required for performing the current task, determining whether reconfiguration information required for performing the current task is stored in one of a plurality of reconfiguration information storage units while the context switching of the register information is performed, if the reconfiguration information required for performing the current task is not stored in one of the plurality of reconfiguration information storage units, outputting a load command for loading the reconfiguration information required for performing the current task, from a memory, loading the reconfiguration information corresponding to the load command from the memory, and storing the reconfiguration information in one of the plurality of reconfiguration information storage units, and selecting the loaded and stored reconfiguration information for context switching of the reconfiguration information required for performing the current task, noting that alternatives are equally available.

With this in mind, and in addition to the above described embodiments, embodiments of the present invention may thus be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system with context switching for a reconfigurable processor, comprising:
a controller with reconfiguration information loading to selectively control a current loading of corresponding reconfiguration information, based upon a particular load command, for the reconfigurable processor for a task from a memory maintaining a plurality of reconfiguration information based upon a determination of whether the corresponding reconfiguration information is pre-stored in at least one of a plurality of reconfiguration information storage units separate from the memory.

2. The system of claim 1, further comprising the reconfigurable processor reconfiguring a program according to the corresponding reconfiguration information and executing the reconfigured program.

3. The system of claim 1, further comprising a central processing unit to output at least one load command, as the particular load command, to the controller for sequentially loading select reconfiguration information to control a plurality of tasks that are to be performed in the system.

4. The system of claim 3, wherein the central processing unit predicts reconfiguration information for a task that is to be next performed, using scheduling information of the plurality of tasks, and outputs a corresponding load command, as the particular load command, for loading the predicted reconfiguration information to the controller.

5. The system of claim 4, wherein the central processing unit outputs the load command for loading the predicted reconfiguration information upon a scheduling information change.

6. The system of claim 4, wherein the central processing unit outputs a load command for loading reconfiguration information corresponding to a task that is to be performed next in sequence, as the particular load command, to the controller if the scheduling information is fixed-order scheduling information.

7. The system of claim 4, wherein the central processing unit outputs a load command for loading reconfiguration information corresponding to a task that is to be performed in the next time period, as the particular load command, to the controller if the scheduling information is time-based scheduling information.

8. The system of claim 1, wherein reconfiguration information loaded from each of the plurality of reconfiguration information storage units comprise a unique identifier to identify respective reconfiguration information, respective reconfiguration data for reconfiguring a program, and respective status information indicating whether the respective reconfiguration information is available.

9. The system of claim 7, wherein the unique identifier is assigned according to corresponding address information of the memory.

10. The system of claim 1, further comprising a reconfiguration information selecting unit to select a reconfiguration information to be loaded by the controller for a task following a current task for context switching.

11. The system of claim 1, further comprising the plurality of reconfiguration information storage units to store particular reconfiguration information for imminent use.

12. The system of claim 11, wherein reconfiguration information stored in each of the plurality of reconfiguration information storage units comprises a unique identifier to identify respective reconfiguration information, respective reconfiguration data for reconfiguring a program, and respective status information indicating whether the respective reconfiguration information is available.

13. The system of claim 12, wherein the unique identifier is assigned according to corresponding address information of the memory.

14. The system of claim 1, wherein the controller determines whether the corresponding reconfiguration information is stored in the plurality of reconfiguration information storage units in response to a load command of a central processing unit, as the particular load command, and loads the corresponding reconfiguration information from the memory if the corresponding reconfiguration information is not stored in any one of the plurality of reconfiguration information storage units.

15. A context switching method, comprising:
selectively loading, based upon a load command, corresponding reconfiguration information for reconfiguring a reconfigurable processor for a task from a memory maintaining a plurality of reconfiguration information based upon a determination of whether the corresponding reconfiguration information is pre-stored in at least one of a plurality of reconfiguration information storage units; separate from the memory and
selecting the corresponding reconfiguration information for context switching of the corresponding reconfiguration information for a next task of the reconfigurable processor.

16. The method of claim 15, further comprising storing the corresponding reconfiguration information in one of the reconfiguration information storage units, if the corresponding reconfiguration information is loaded from the memory, before selecting the corresponding reconfiguration information for the context switching.

17. The method of claim 15, further comprising reconfiguring the reconfigurable processor to reconfigure a program according to the corresponding reconfiguration information and executing the reconfigured program.

18. The method of claim 15, further comprising receiving the load command for loading the corresponding reconfiguration information for the next task that is to be performed after a current task is performed.

19. The method of claim 15, further comprising outputting the load command for loading the corresponding reconfiguration information for the next task that is to be performed after a current task is performed.

20. The method of claim 19, wherein, in the outputting of the load command, the corresponding reconfiguration information for the next task is predicted using scheduling information for a plurality of tasks before outputting the load command.

21. The method of claim 20, wherein, in the outputting of the load command, the load command is output based upon when the scheduling information changes.

22. The method of claim 20, wherein, in the outputting of the load command, if the scheduling information is fixed-order scheduling information, the load command is a load command corresponding to a task that is to be performed next in sequence.

23. The method of claim 20, wherein, in the outputting of the load command, if the scheduling information is time-based scheduling information, the load command is a load command corresponding to a task that is to be performed in a next time period.

24. The method of claim 15, wherein reconfiguration information stored in each of the plurality of reconfiguration information storage units comprises a unique identifier to identify respective reconfiguration information, respective reconfiguration data for reconfiguring a program, and respective status information indicating whether the respective reconfiguration information is available.

25. The method of claim 24, wherein the unique identifier is assigned according to corresponding address information of the memory.

26. The method of claim 15, wherein the selective loading of the corresponding reconfiguration information comprises:
determining whether the corresponding reconfiguration information is stored in any one of the plurality of reconfiguration information storage units; and
loading the corresponding reconfiguration information from the memory if the corresponding reconfiguration information is not stored in any one of the plurality of reconfiguration information storage units.

27. At least one medium comprising computer readable code to control at least one processing element to implement the method of claim 16.

28. A context switching method, comprising:
performing context switching of register information for performing a current task of a reconfigurable processor;
determining whether corresponding reconfiguration information for the current task for reconfiguring the reconfigurable processor is stored in any of a plurality of reconfiguration information storage units;
outputting a load command for loading the corresponding reconfiguration information from a memory maintaining a plurality of reconfiguration information if the corresponding reconfiguration information is determined to not be stored in any of the plurality of reconfiguration information storage units;
selectively loading the corresponding reconfiguration information from the memory and storing the corresponding reconfiguration information in one of the plurality of reconfiguration information storage units, separate from the memory; and
selecting the corresponding reconfiguration information, as stored in the one of the plurality of reconfiguration information storage units, for context switching of the corresponding reconfiguration information for a current task.

29. At least one medium comprising computer readable code to control at least one processing element to implement the method of claim 28.
